(19) United States
(12) Patent Application Publication
(10) Pub. No.: US 2013/0326237 A1
(43) Pub. Date: Dec. 5, 2013

(54) UNINTERRUPTABLE PC POWER UNIT FOR USE IN PERSONAL COMPUTER AND SERVERS

(71) Applicants: Shani HOLDENGREBER, Moshav Gan Yashia (IL); Asaf Lahav, Ramat Hasharon (IL); Aviv Mor, Ramat Hasharon (IL)

(72) Inventors: Shani HOLDENGREBER, Moshav Gan Yashia (IL); Asaf Lahav, Ramat Hasharon (IL); Aviv Mor, Ramat Hasharon (IL)

(21) Appl. No.: 13/483,527

(22) Filed: May 30, 2012

(51) Int. Cl. G06F 1/26

(52) U.S. Cl. 713/300

(57) ABSTRACT

Uninterruptable PC Power Unit (UPCPU) for a personal computer (PC) replaces the power supply of a PC. The UPCPU comprises an internal battery to be used during AC power interruption. The UPCPU may be connected to external batteries installed in the PC's 5.25″ or 3.5″ drive bays. The UPCPU may supply 12V, uninterrupted power to power external devices such as a display or modem. The UPCPU is capable of safely saving work in progress and force shutdown or hibernation state of the PC.

### FIELD OF THE INVENTION

Embodiments of the present invention relate to an integrated Uninterruptable PC Power Unit (UPCPU) for use in personal computer and servers.

### BACKGROUND OF THE INVENTION

Unlike laptop computers that include a battery, Personal Computers (PC) and servers are generally connected to an AC power supplied from the main electricity grid. The computer's power supply converts the AC power to the several low voltage DC values need for the operation of the processor, memory and other components such as Hard Drive (HD) Input and Output (I/O) devices, et. Main power grid is susceptible to faults such as surges, blackouts and drops in voltage (brown-outs). Any interruption or deviation in the AC power that exceed the tolerance of the power supply, causes immediate interruption in the DC voltages supplied to the computer and immediate stop of its operation. Such unintended cessation in the computer's operation may cause loose of data that is in the computer's volatile memory. Additionally, files that were in the process of being written to HD may be irreversibly corrupted and lost. In some cases, damage may be caused to system and operation system files, causing severe damage to the operation of the computer. In some cases hardware such as the power supply, HD or other components such as mother board may be damaged by abnormal voltages caused by spikes and surges in the AC.

To avoid such potential damages, AC surge protectors and AC power stabilizers may be used.

To supply power during long blackouts, local power generator may be used. However, these generators are large and are in use in critical places such as in hospitals, etc. In case of a power blackout, he typical home or small office user, usually requires uninterrupted power for a short duration to enable him to save to the HD his ongoing work, or to complete his immediate tasks and to safely turn-off his computer.

To achieve such requirements, Uninterruptable Power Supply (UPS) are used. UPS devices are made in several sizes and capacities to meet maximum supplied power (Watts) and duration of power available during power blackout (battery capacity). The UPS devices used today stands as a “man in the middle” and are connected between the main outlet and the PC. The UPS of the art provides surge and spike protection, regulates the voltage, and on main power failure the UPS of the art uses it internal battery to generate AC to substitute the failed main AC power.

The PC Power Supply (PCPS) receives main AC power (typically 110 or 220V at 50 or 60 Hz, depending on country), converts the AC power to DC voltages required for the PC operation.

In 1998, a group of companies including Intel, Hewlett-Packard, NEC, Dell, Data General, Micron, and Compaq created the Server System Infrastructure (SSI), an industry initiative to promote industry-standard form factors covering common server hardware elements such as chassis, power supplies, motherboards, and other components. The idea was to be able to design network servers that could use industry-standard interchangeable parts. More about SSI can be found at www.ssiforum.org. In many ways a low-end server is a high-end PC, and many high-end components that were once found only on servers have trickled down to standard PCs. This trickle-down is especially true when it comes to power supplies. Over the years, several standards were adopted that regulates the electrical specifications, electrical connectors, and physical dimensions and connections (form factors) of PC components such as PCPS, HD, and Optical Drives (OD) such as CD and DVD readers and writers. Such standards allow combining hardware components from any manufacturer to be integrated into a PC. Specifically, housings for PCs include bays, attachments and locations adapted to receive and hold standard size components. Over the years these standards evolved.

A typical PC housing includes bays for: one PCPS; one or few internal HDs, one or few bays or ODs as well as a space for a mother board, external connections and other electronics.

### SUMMARY OF THE EMBODIMENTS

It is an aspect of the invention to provide an Uninterruptable PC Power Unit (UPCPU) for a personal computer (PC) replaces the power supply of a PC. The UPCPU comprises an internal battery to be used during AC power interruption. The UPCPU may be connected to external batteries installed in the PC's 5.25″ or 3.5″ drive bays. The UPCPU may supply 12V, uninterrupted power to power external devices such as a display or modem. The UPCPU is capable of safely saving work in progress and force shutdown or hibernation state of the PC.

It is another object of the current invention to provide an Uninterruptable PC Power Unit (UPCPU) for a personal computer (PC) comprising: an AC main power input; a surge protector capable of filtering AC power received from said AC main power input; an AC to DC converter, capable of producing DC power from AC power received from said surge protector; an internal battery pack, capable of storing power received from said AC to DC converter; an input selector, capable of selecting: the DC power from said DC to DC converter, when AC power is available at said AC main input; and the DC power from said internal battery pack, when AC power is not available at said AC main input; a DC to DC converter, capable of receiving DC power from said input selector, and supplying a plurality of voltages needed for operational of a PC to power supply connectors, wherein the UPCPU is sized to replace a power supply of a PC.

In some embodiments the UPCPU further comprises at least one external battery, wherein: said input selector, further capable of selecting the DC power from said external battery, when AC power is not available at said AC main input; said at least one external battery is capable of being charged by power received from the UPCPU, said at least one external battery is capable of supplying power to said input selector.

In some embodiments the UPCPU further comprises at least one external battery, wherein said at least one external battery is sized to be installed in at least one of the 5.25″ bays of said PC.

In some embodiments the UPCPU further comprises at least one external battery, wherein said at least one external battery is sized to be installed in at least one of the 3.5″ bays of said PC.

In some embodiments the UPCPU further comprises at least one external battery, wherein said at least one external battery is installed outside said PC.

In some embodiments the UPCPU further comprises: a real time monitoring circuit, capable of monitoring the operation of the UPCPU; and a USB communication function, capable of communication with the PC in which said UPCPU is installed.

In some embodiments the external battery further comprises a balanced charger.

In some embodiments the balanced charger comprises a communication function capable of communicating with said USB communication function.

In some embodiments the communication function in a balanced charger of an external battery is capable of providing to the USB communication function information indicative of the type of said external battery.

In some embodiments the communication function in a balanced charger of an external battery is capable of providing to said USB communication function information indicative of the state of charging of said external battery.

In some embodiments the UPCPU further comprises an external power connector, capable of providing uninterruptable DC power.

In some embodiments the UPCPU further comprises an external power connector, receiving uninterruptable DC power from said input selector.

In some embodiments the UPCPU further comprises an external power connector, receiving uninterruptable DC power from said DC to DC converter.

In some embodiments the external power connector is capable of powering a display.

In some embodiments the AC to DC converter is a 12 Volts converter.

In some embodiments the real time monitoring circuit is capable of forcing safe shutdown of said PC when AC power is not available at said AC main input.

In some embodiments forcing safe shutdown of said PC is performed when charge level in batteries internal and external to the UPCPU is below a predefined threshold.

In some embodiments forcing safe shutdown of said PC is preceded by disconnection of power to non essential PC hardware components to save power and extend the time duration that power is available from the batteries.

In some embodiments disconnection of power to non essential PC hardware components comprises disconnecting at least component selected from a group consisting of: display; CD; DVD; and graphic card.

In some embodiments forcing safe shutdown of said PC is preceded by reducing the operation speed and CPU power usage.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Unless marked as background or art, any information disclosed herein may be viewed as being part of the current invention or its embodiments.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments of the present invention only, and are presented in the cause of providing what is believed to be the most useful and readily understood description of the principles and conceptual aspects of embodiments of the invention. In this regard, no attempt is made to show structural details in more detail than is necessary for a fundamental understanding of the embodiments; the description taken with the drawings making apparent to those skilled in the art how the several forms of the invention may be embodied in practice. In the accompanying drawings:

FIG. 1 schematically depicts a power supply for a PC (PCPS) computer as known in the art.

FIG. 2 schematically depicts a block diagram of a PC connected to a UPS as known in the art.

FIG. 3 schematically depicts a block diagram of a PC with an Uninterruptable PC Power Unit (UPCPU) installed according to an exemplary embodiment of the current invention.

FIG. 4 schematically depicts a block diagram of a UPCPU according to an exemplary embodiment of the current invention.

FIG. 5 schematically depicts a battery pack according to an exemplary embodiment of the current invention.

FIG. 6A schematically depicts a block diagram of a PC 200 with an Uninterruptable PC Power Unit (UPCPU) installed, showing active power lines while UPCPU 300 is in normal operation mode, PC 200 is operational, and the battery packs are not fully charged, according to an exemplary embodiment of the current invention.

FIG. 6B schematically depicts a block diagram of a PC 200 with an Uninterruptable PC Power Unit (UPCPU) installed, showing active power lines while UPCPU 300 is in normal operation mode, PC 200 is operational, and the battery packs fully charged, according to an exemplary embodiment of the current invention.

FIG. 6C schematically depicts a block diagram of a PC 200 with an Uninterruptable PC Power Unit (UPCPU) installed, showing active power lines while AC power is unavailable to UPCPU 300 is in its normal operation mode, PC 200 is operational, and the battery packs supplies the power, according to an exemplary embodiment of the current invention.

FIG. 6D schematically depicts a block diagram of a PC 200 with an Uninterruptable PC Power Unit (UPCPU) installed, showing active power lines while UPCPU 300 is in sleep mode wherein PC 200 is not operational according to an exemplary embodiment of the current invention.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In discussion of the various figures described herein below, like numbers refer to like parts. The drawings are generally not to scale.

Some optional parts were drawn using dashed cables. For clarity, non-essential elements were omitted from some of the drawings.

To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like.

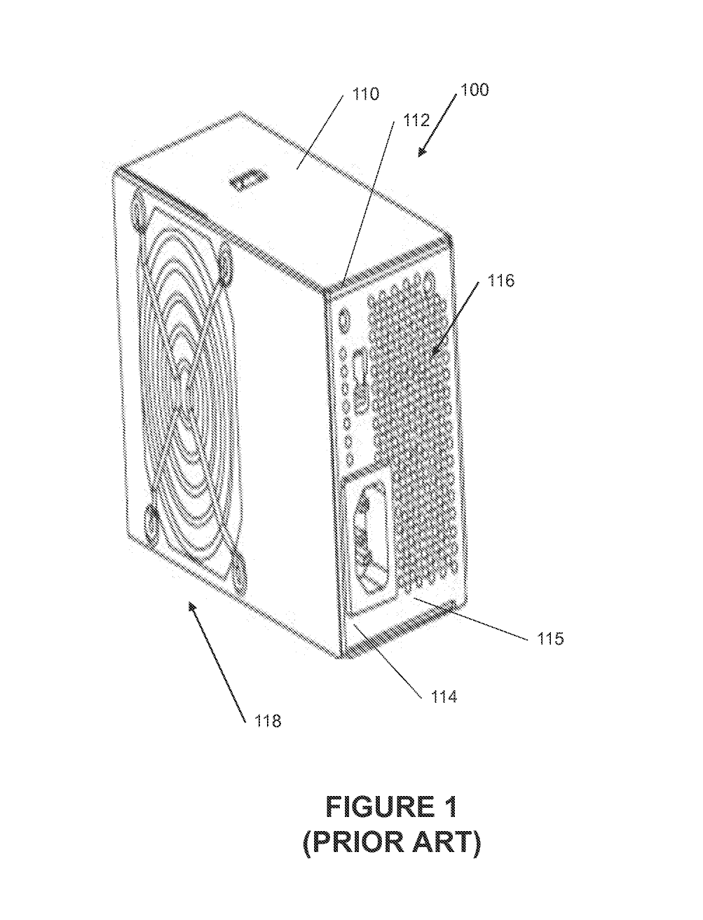

FIG. 1 schematically depicts a power supply for a PC (PCPS) computer as known in the art.

PCPS 200 seen here is but one of several forms of PCPS used in the computer industry, it comprises a housing 110 having an AC input connector 114, ventilation holes 116, and an on-off switch 112 on its back wall 115 which is typically exposed on the back of the housing of the computer. Fan 118 is seen here on the side wall of housing 110, but the fan may be located elsewhere. Power cables are not seen in this figure for drawing clarity. AC input connector 114 is a 3 prongs connector (one phase AC and ground)

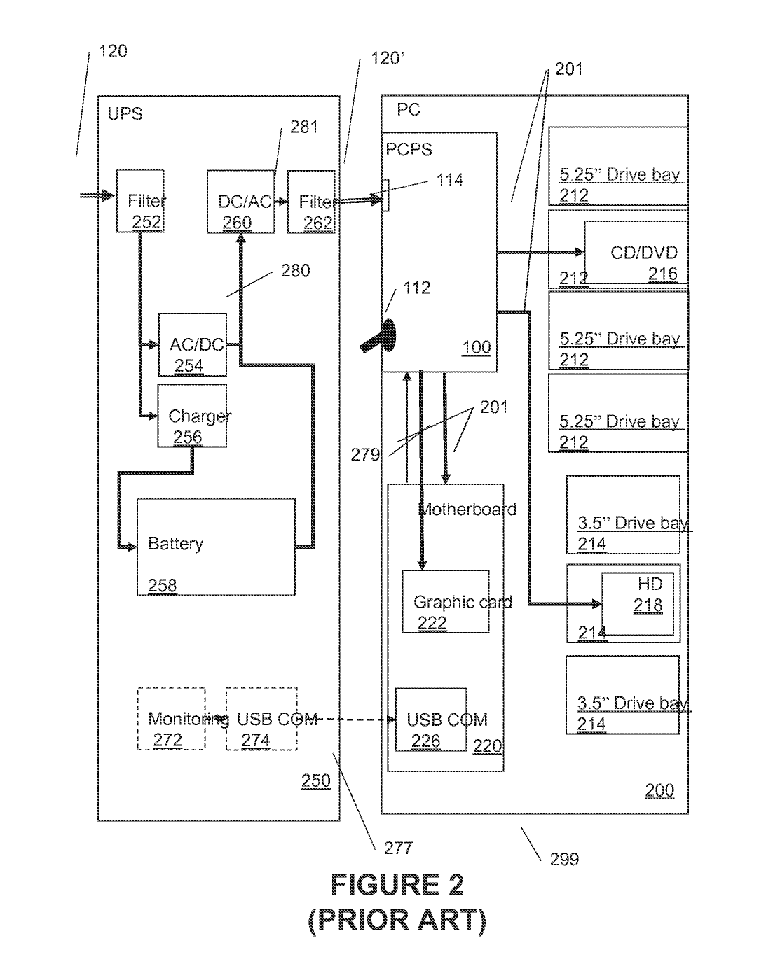

FIG. 2 schematically depicts a block diagram of a PC connected to a UPS as known in the art.

To protect PC 200 against variations, spikes or lose of power on main AC cable 120, a UPS 250 is inserted in cable. UPS 250 provides reliable power via reliable AC cable 120′ to PC 200 from its internal battery 250 in case power is lost at AC cable 120.

Operation of UPS 250 is explained here to show the similarities and differences between using external UPS as known in the art and an integrated Uninterruptable PC Power Unit (UPCPU) according to the current invention.

UPS 250 receives AC power from main electrical grid via AC cable 120. After filtration and spike protection in filter 252, the filtered AC power is used by charger 256 to charge battery 258 and keep it charged. In parallel, Filtered AC power is also converted by AC/DC converter 254 to DC voltage 280 which is fed to DC/AC inverter which produces AC power 281. AC power 281 is filtered by filter 262 and is fed to PC 200 as uninterrupted AC power 120′. When AC power in cable 120 is missing or deficient, DC power 280 is supplied to inverter 260 from battery 258 instead of AC/DC converter 254.

Optional monitoring function 272 monitors the availability of AC power by monitoring AC cable 120 and charging state of battery 258. When AC power in cable 120 is unavailable, and battery 258 have reached a predetermined level, monitoring function uses USB COM communication function to communicate with USB COM communication unit 262 in PC 200 to initiate safe shutdown of PC 200 as long as power is still available at uninterrupted AC cable 120′.

PC 200 is housed in a housing 299. Housing 299 holds PCPS 100, a plurality of 5.25″ drive bays 212 (4 are seen in this figure) and a plurality of 3.5″ drive bays 214 (3 are seen in this figure). PC 200 seen in this figure shows one of the four 5.25″ drive bays 212 occupied by a CD/DVD optical dive 216, and one of the three 3.5″ drive bays 214 occupied by a hard drive (HD) 218. Additionally, housing 299 houses motherboard 220, and optional graphic card 222.

PCPS 100 provides power to all the electronic components in PC 200 using standard power supply cables 201 (several standards may be used within the same PC 200). PCPS 100 may be turned off by externally activated switch 112, or may be turned off or put in sleep mode by a command from motherboard 220 via command channel 279. For drawing clarity elements such cooling fans, Input/Output port (I/O), peripheral such as keyboard, mouse, display and the likes were not shown in this figure.

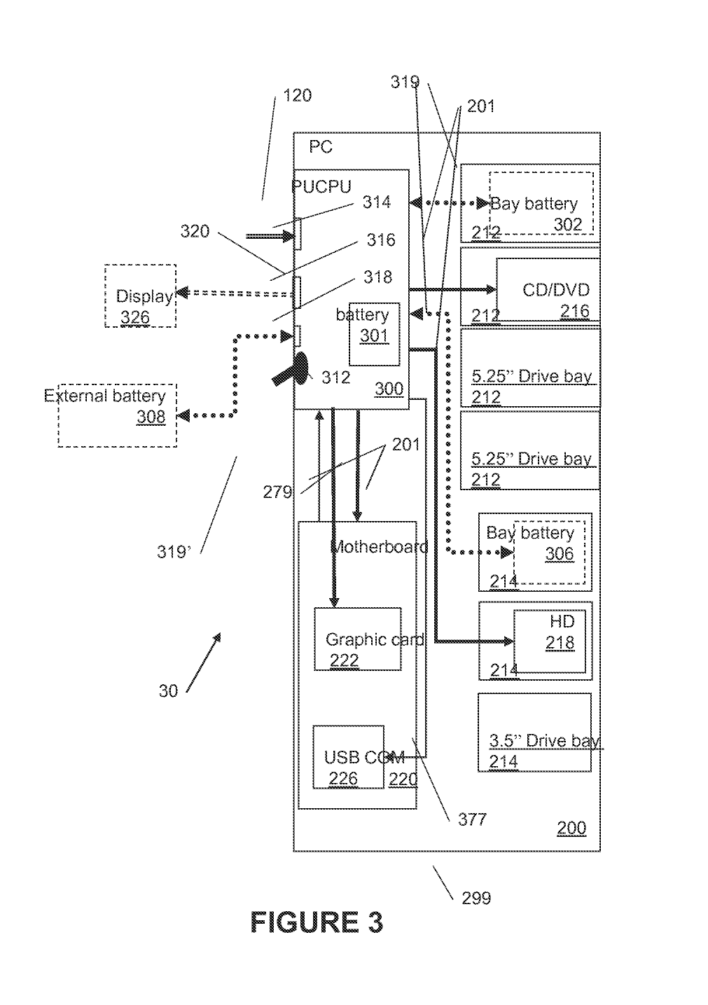

FIG. 3 schematically depicts a block diagram of a computing system 30 comprising a PC 200 with an Uninterruptable PC Power Unit (UPCPU) 300 installed according to an exemplary embodiment of the current invention.

It is an aspect of system 30 according to the current invention to provide a personal computer or a server 200 with uninterruptable power without the need for an external UPS unit, with minimal modification and with improved power efficiency.

To achieve this goal, it is sufficient to replace in a PC 200 the PCPS 100 with a UPCPU 300.

UPCPU 300 (details of which will be further disclosed in the following figures) comprises an internal battery pack 301 that enables it to continue to supply power to PC 200 in the event that power is lost in AC cable 120. AC input connector 314 is a 3 prongs connector (one phase AC and ground)

Monitoring function, and communication function (not seen in this figure) issue a warning message and shutdown or hibernation command to motherboard 220 via cable 377 and USB COM 226 in manner similar to the operation of monitoring function 272 and USB COM 274 seen in FIG. 2. It should be noted that communication protocols other than USB protocols may be used. Optionally, UPCPU 300 comprises a plurality of communication ports and capable of supporting several communication protocols.

Optionally, at least one, and optionally a plurality of additional batteries are used to extent the duration in which UPCPU 300 is capable to supply power to PC 200 after power is lost in AC cable 120.

A standard PC housing 299 comprises a plurality of 5.25″ and 3.5″ drive bays (212 and 214 respectively). Often, only one of each is occupies, and in most case at least one is empty. Bays 212 and 214 conform to industry standards and comprise physical connections to secure bay battery packs 302 and 306 respectively. Optional bay battery packs 302 and 306 are connected to UPCPU 300 with battery pack cables 319. UPCPU 300 charges the batteries in bay battery packs 302 and 306 and keeps them charged when power is available at AC cable 120. When power is not available at AC cable 120, bay battery packs 302 and 306 supply power to UPCPU 300, which uses this power to provide uninterrupted power to PC 200 via power supply cables 201. Optionally, bay battery pack cables 319 comprises not only leads to the terminals of the batteries in bay battery packs 302 and 306, but also channels for communicating with these battery packs.

It should be noted that number of bay battery packs 302 and 306 may very from non to the maximum available drive bays 212 and 214.

Optionally, UPCPU further comprises an external battery pack connector 318, preferably exposed at the back wall of the housing of UPCPU 300, and thus exposed at the back wall of housing 299 of PC 200. External battery pack connector 318 connects the optional external battery pack 308, to UPCPU 300 via external battery pack cable 319′. External battery pack cable 319 may be identical or similar to bay battery pack cables 319.

The modular architecture allows the user flexibility in choosing and changing the number battery packs used by the UPCPU and thus to trade cost with duration of available power.

Optionally, UPCPU further comprises an external power connector 316, preferably exposed at the back wall of the housing of UPCPU 300, and thus exposed at the back wall of housing 299 of PC 200. External power connector 316 provides uninterrupted power, via external peripheral cable 320 to external peripherals such as display 326. Additionally, optionally or alternatively, other peripherals, and optionally a plurality of other peripherals may be connected to external power connector 316. For example, peripherals such as (but not limited to) modems, external HD's, printers, cameras, audio units, and scanners may be connected to external power connector 316. It should be noted that having a display connected to external power connector 316 allow the user to continue operating PC 200 as long as any of battery packs 301, 302, 306 or 308 are not depleted. However, for the purpose of protecting PC 200 from ill effects of power loss at AC cable 120 and keeping data integrity, it may be sufficient that a command causing motherboard 220 to perform data save, perform safe shutdown or to go into hibernation is delivered via cable 377, and that such commands are executed before all the battery packs are depleted. Optionally, UPCPU monitors the state of motherboard 220 via cable 279 and enters a sleep mode or off mode once safe shutdown was completed. Thus, display 326 is turned off too once safe shutdown was completed.

Optionally an external DC/AC converter may be connected to external power connector 316 to provide uninterrupted AC power. Optionally an external DC/DC may be connected to external power connector 316 to provide uninterrupted DC power at other voltages. For example such uninterrupted power may be used for powering external HD, USB powered peripherals, and the likes.

Optionally, switch 312 preferably exposed at the back wall of the housing of UPCPU 300, and thus exposed at the back wall of housing 299 of PC 200 is a multi-state selector allowing UPCPU 300 to be set to states such as “off”, “normal”, and optionally “charge only” modes, wherein: in “off' mode UPCPU 300 is inactive; in “normal” mode, operation is as disclosed above; and in “charge only” mode, no power is supplied to standard power supply cables 201 and external power connector 316, but battery packs 301, 302, 306 or 308 are being charged or kept fully charged.

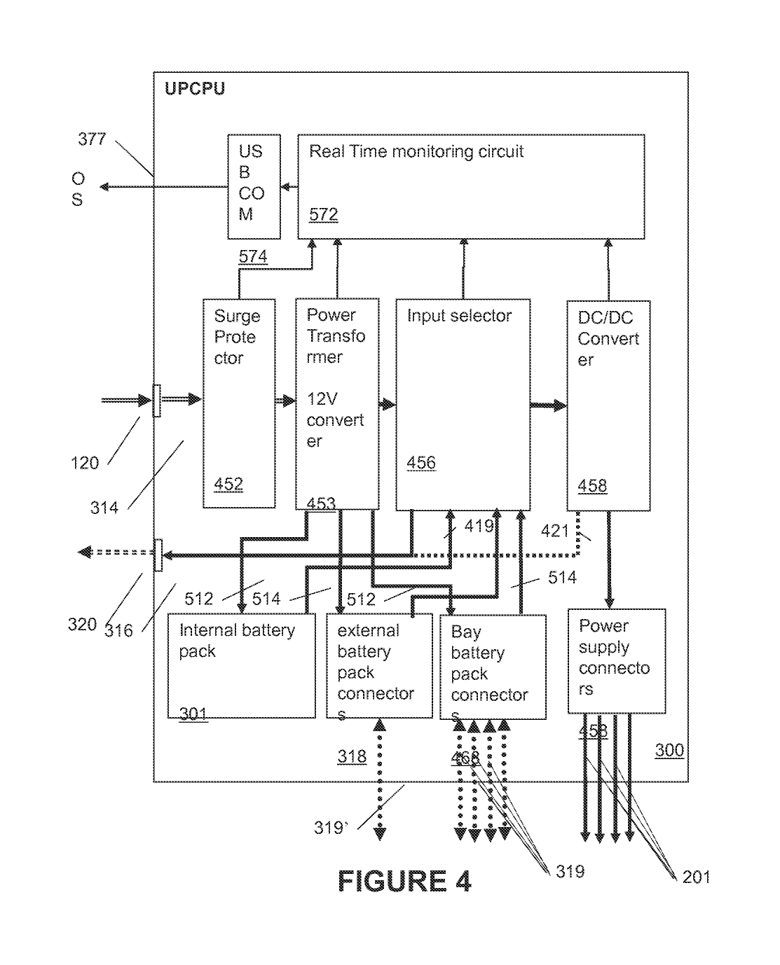

FIG. 4 schematically depicts a block diagram of a UPCPU 300 according to an exemplary embodiment of the current invention.

UPCPU 300 receives AC power from AC cable 120 which is connected to a standard main outlet on one side and to AC connector 314 exposed at the back of UPCPU 300. AC power is protected against surges and spikes in surge protector 452 and is converted to 12 Volts DC at power transformer and 12V convertor 453. Convertor 453 may comprise a step down transformer and rectifying circuitry as known in the art, however other converter technology may be used. Optionally, Convertor 453 is design for a specific AC voltage such as 110V or 120V; however, it may be designed to accept any standard household AD power or to automatically adapt to the AC power connected to it.

DC voltage from converter 453 is transferred through input selector 456 to DC/DC converter 458 which generates the voltages needed for the operation of PC 200 (such as +/−12V, +/−5V, and 3.3V) which are supplied to the components of PC 300 via standard power supply cables 201. DC voltage from converter 453 is also used to charge (or keep charged) the following battery packs via 12V input lines 512 (only two are marked for drawing clarity):
Internal battery pack 301, located inside UPCPU 300;
Optional bay battery packs 302 and 306, located in drive bays 212 and 214 respectively, and connected to UPCPU by battery pack cables 319 and the optional bay battery pack connector 468; and
Optional external battery pack 308, located outside PC 200, and connected to UPCPU by external battery pack cables 319′ and the optional external battery pack connector 318.

It should be noted that optionally, priority is given to supplying power to DC/DC converter 458 (and optionally display 326) over charging the battery packs. Thus, to prevent overloading and/or overheating converter 453, only excess power available to converter 453, after the power demand of DC/DC converter 458 was met is used for charging the batteries. Optionally, priority is given to charging internal batteries over charging bay batteries or external batteries. Optionally priority may be reconfigured by the user.

Additionally and optionally, DC voltage from converter 453 is transferred via line 419 and through external power connector 316 to provide uninterrupted power, via external peripheral cable 320 to external peripherals such as display 326. Alternatively, and optionally, DC voltage from DC/DC converter 458 is transferred via line 421 and through external power connector 316 to provide uninterrupted power, via external peripheral cable 320 to external peripherals such as display 326. In this way, power supplied to external power connector 316 is regulated and is not depending on the voltage in the batteries, which may depend on the charging level.

When AC power is not available, power is supplied to the DC/DC converter 458 by from battery packs 301, 302, 306 or 308 through input selector 456 via 12V output lines 514 (only two are marked for drawing clarity). Input selector selects 12V converter 453 to supply power to DC/DC converter 458 when 12V voltage is available at the output of converter 453, and selects one (or few) of the battery pack when 12V voltage is not available at the output of converter 453. Optionally, priority is given to using external bay batteries or external batteries over internal battery pack 301. Optionally priority may be reconfigured by the user.

In some embodiments, external battery pack 308 may be removed, attached or replaced while PC 200 is in operation (hot battery swipe). For example, spare external battery may be charged and used in another PC 200, or kept for use when needed. Similarly, a defective external battery pack 308 may be replaced without disturbing the operation of PC 200.

In some embodiments, 5.25″ drive bays 212 may be opened from outside housing 299 of PC 200, such that bay battery pack 302 may be removed, attached or replaced while PC 200 is in operation (hot battery swipe). For example, spare bay batteries may be charged and used in another PC 200, or kept for use when needed. Similarly, a defective bay battery pack 308 may be replaced without disturbing the operation of PC 200.

When AC power is available, and switch 312 is set to optional position “charge only”, DC/DC converter is deactivated, PC 200 is turned off but battery packs are charged (or kept fully charged) by 12V converter 453. Optionally, a soft switch controlled by the user from front panel of PC 200, and/or I/O devices such the keyboard and mouse is used (via cable 279) in addition to switch 312 to determine the state of UPCPU 300.

Real time monitoring circuit 572 monitors the operation of the components of UPCPU 300, and optionally the operation and state of bay and external batteries 308, 302 and 306. This information is transferred to motherboard 220 via USB CON 574 and cable 377, and preferably used by the Operation System (OS) executed by PC 200 to display status messages, fault warnings, and perform safe shutdown of PC 200.

For example, real time monitoring circuit 572 may be based on a micro processor circuit that communicates with the components within the UPCPU, performs calculations and sends relevant information to the OS using USB communication port. In addition, monitoring circuit 572 may command hardware disconnection of non essential PC components to save power and extend the time duration that power is available from the batteries. For example, when only low capacity internal battery pack 301 is available, or when battery packs are not fully charged, scarce power may be saved by cutting power to the display 462, CD/DVD 216 and/or graphic card 222 while data is saved from volatile memory to HD 218 before PC shutdown.

Additionally and optionally, system 30 may have the following features and advantages:

In some embodiments real time circuit monitoring 572 may control the speed step technology during power failure, reducing the operation speed and CPU power usage to prolonging run time.

In some embodiments real time monitoring circuit 572 may interface with an application executed by the OS and create log file which saves relevant data during power failure for future reference.

In some embodiments real time monitoring circuit 572 may calculate the power used by system, and interface with the OS to display for the user a status display showing a power meter, and/or gives statistics of power used to the user.

In some embodiments real time monitoring circuit 572 may initiate sending notifications on power fluctuations or failure, for example by sending email or other messages to remote locations or using on-cable logging.

In some embodiments real time monitoring circuit 572 may initiate a process of entering power saving mode to extend up time during a power failure when AC fails or when AC fluctuations were detected which includes on or few of: Turning off hard-disks, disconnecting USBs, disabling CD-Rom, stopping anti-virus scans, stopping archiving processes, and/o reducing CPU clock rate.

In some embodiments real time monitoring circuit 572 may initiate power-up of PC 200, or wake-up from hibernation, sleep or exit from power saving mode when AC power resumes after failure.

In some embodiments real time circuit monitoring 572 may initiate a process of saving a memory snap-shot before initiating a PC shut-down and reload the saved snap-shot to memory on power up.

In some embodiments real time circuit monitoring 572 may initiate disconnection of 12V converter 452 from AC power when AC power AC fails or when AC fluctuations were detected, and reconnect converter 452 to main power only after predetermined duration (for example 1-10 minutes) of stable main AC power was observed. AC stability may be evaluated by surge protector 452 and reported to real time circuit monitoring 572.

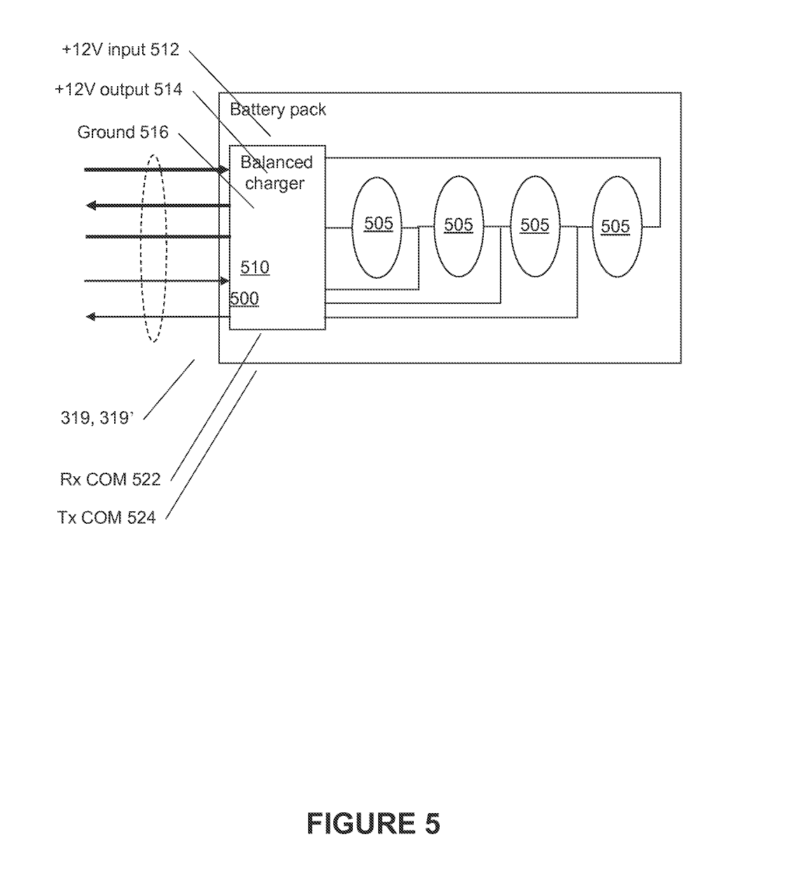

FIG. 5 schematically depicts a battery pack according to an exemplary embodiment of the current invention.

Battery packs 500, (generally stands for such as packs 301, 302, 206 and 308) comprise a plurality of rechargeable battery cells 505 (four such cells are seen for drawing clarity, but number of cells, and their wiring configuration (in series, parallel or mixed wiring) may be different.

In the depicted embodiment, cable 319, 319′ is a five leads cable comprising of 12V input line 512, 12V output line 514, ground line 516 and communication channel comprising Rx COM line 522 and Tx COM line 524.

A balanced charger 510 receives 12V input power from 12V converter 453 via 12V input line 512 in and distributes the power to the battery cells 505 according to each battery state thus providing maximum life cycle for each battery.

When AC power is unavailable at AC cable 120, power may be drawn from battery pack 500 via 12V output line 514.

Balance charger 510 may optionally comprise logic and/or monitoring function (not marked in this figure), capable of communicating with real time monitoring circuit 572 using Rx COM line 522 and Tx COM line 524. For example, this communication enables monitoring circuit 572 to be aware of, and optionally transfer to the motherboard 220 information related to the state of battery pack 550. Additionally, this information may be used for configuring and prioritizing the operation of UPCPU 300 according to the availability and charge state of battery packs 301, 302, 306 and 308.

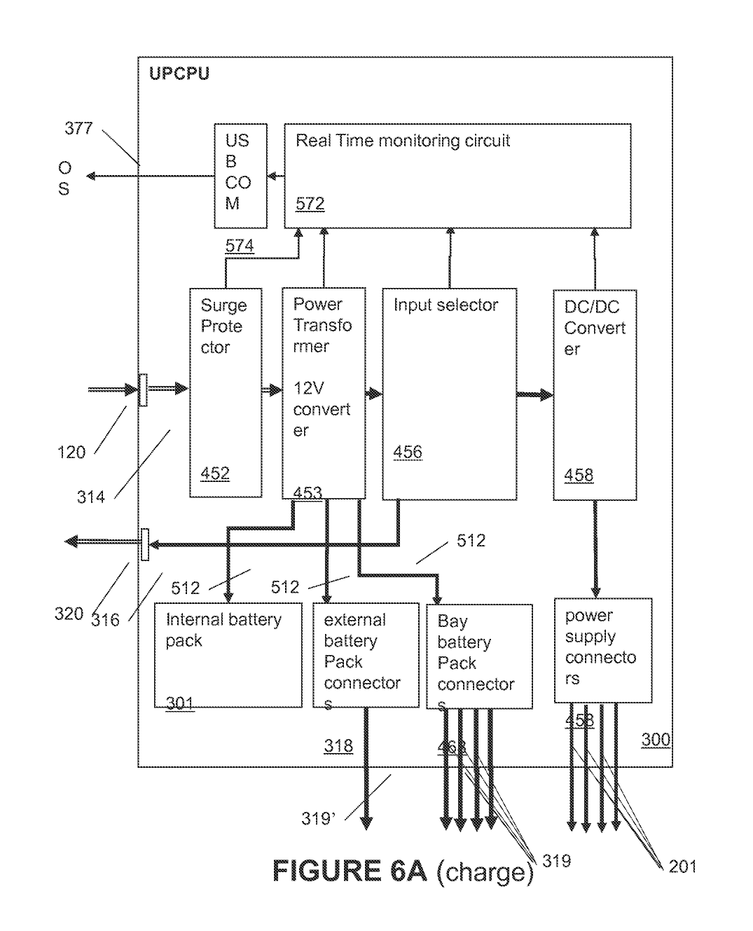

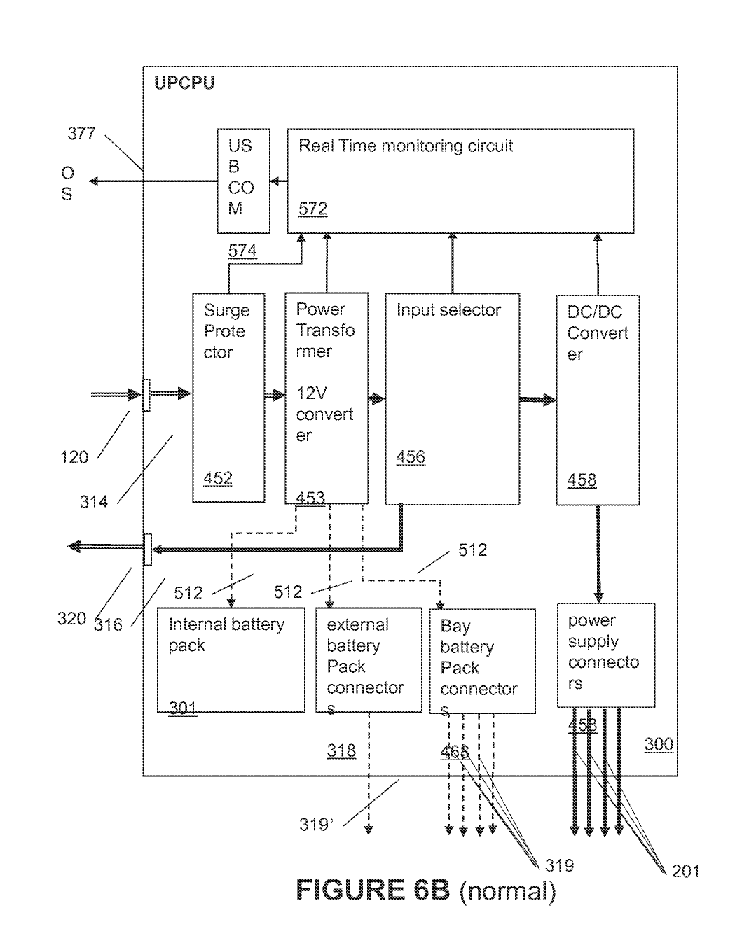

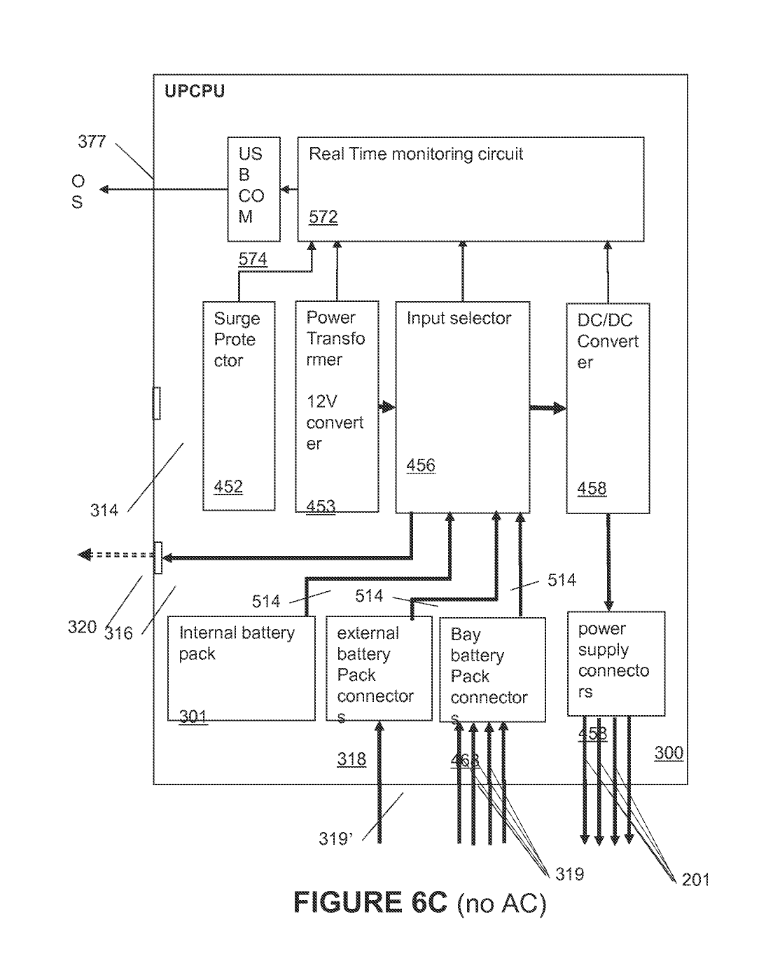

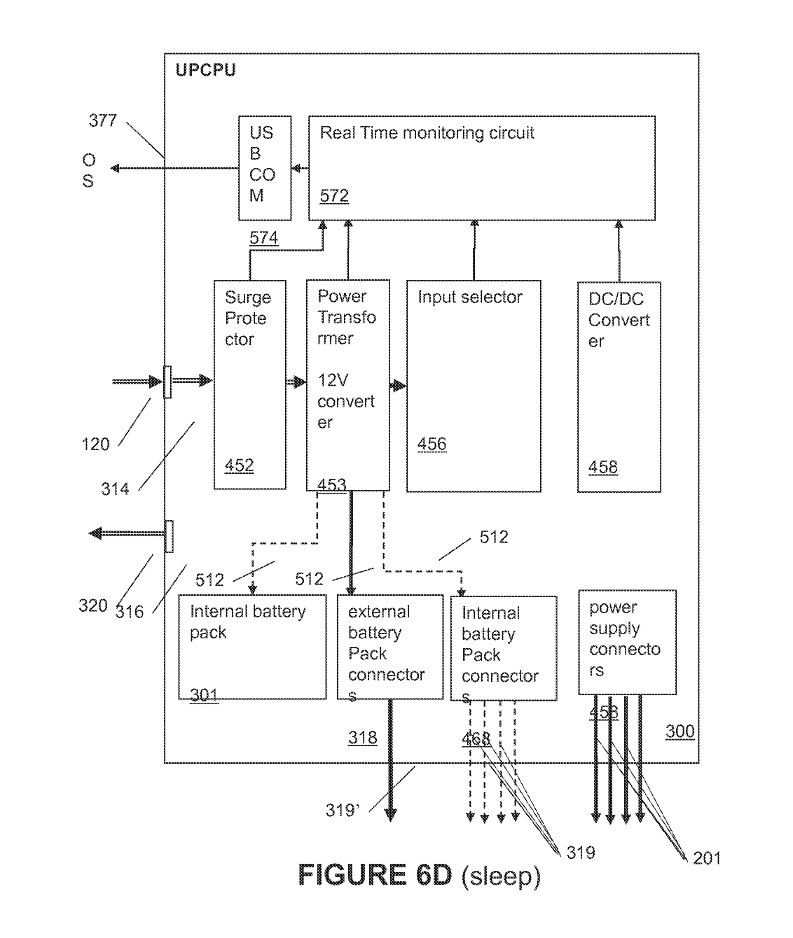

FIGS. 6A-D schematically depicts a block diagram of a PC 200 with an Uninterruptable PC Power Unit (UPCPU) installed, showing active power lines while UPCPU 300 is in different operational states, according to an exemplary embodiment of the current invention.

FIG. 6A schematically depicts a block diagram of a PC 200 with an Uninterruptable PC Power Unit (UPCPU) installed, showing active power lines while UPCPU 300 is in normal operation mode, PC 200 is operational, and the battery packs are not fully charged, according to an exemplary embodiment of the current invention.

This state may be encountered when the system is first used, when the system is used after being unplugged for duration sufficiently long for battery cells 505 to lose their charge or when AC power is restored after it failed.

AC power is available, and DC power is supplied by 12V converter 543 to DC/DC converter 548, to external power connector 316 as well as to battery packs 301, 318, 306 and 302.

FIG. 6B schematically depicts a block diagram of a PC 200 with an Uninterruptable PC Power Unit (UPCPU) installed, showing active power lines while UPCPU 300 is in normal operation mode, PC 200 is operational, and the battery packs fully charged, according to an exemplary embodiment of the current invention.

This state may be encountered when the system was used for duration sufficiently long for battery cells 505 to be fully charged.

AC power is available, and DC power is supplied by 12V converter 543 to DC/DC converter 548, to external power connector 316. Cells 505 in battery packs 301, 318, 306 and 302 are kept fully charged by trickling currents, depicted by thin dashed lines 512.

FIG. 6C schematically depicts a block diagram of a PC 200 with an Uninterruptable PC Power Unit (UPCPU) installed, showing active power lines while AC power is unavailable to UPCPU 300 is in its normal operation mode, PC 200 is operational, and the battery packs supplies the power, according to an exemplary embodiment of the current invention.

This state is encountered when AC power failed or was disconnected, and at least on of the battery packs is sufficiently charged.

DC power is supplied by at least one of the 12V output line 514 input selector 454, and through it to DC/DC converter 548 and to external power connector 316.

FIG. 6D schematically depicts a block diagram of a PC 200 with an Uninterruptable PC Power Unit (UPCPU) installed, showing active power lines while UPCPU 300 is in sleep mode wherein PC 200 is not operational according to an exemplary embodiment of the current invention.

In the example depicted in this figure, AC power is available but input selector 456 does not transfer power of DC/DC converter 548 or to external power connector 316. In the depicted example, battery packs 301, 306 and 302 are fully charges, while external battery pack 308 is being charge

Referring again to FIG. 2 showing a block diagram of a PC connected to a UPS as known in the art, the inefficient use of battery 258 during AC failure is apparent. During AC failure, low voltage DC power from battery 258 is converted high voltage AC power 120′ by DC/AC inverter 260. The produced AC is then filtered to remove the high frequency harmonics by filter 262 only to be converted back to low voltage DC power within PCPS 100. The unnecessary conversions from DC to AC and back to DC, and the transformation from low voltage to high voltage and back to low voltage causes severe reduction in power efficiency. In contrast, during AC failure, UPCPU of the current invention uses the low voltage CD power as stored in the battery packs directly (by DC/DC converter 458). As a result the power efficiency of system 30 of the current invention may be as high as twice the efficiency of the system of the art. The higher efficiency of the inventive system comparing to UPS system of the art was proved experimentally. In contrast to the systems of the art, wherein during battery operation the system converts in the UPS the DC in the battery to AC, and then back from AC to DC in the PCPS, in invention uses directly the DC power of the batteries. Thus, the current invention may enable longer duration of operation with the same battery capacity. Much of the bulk and weight of UPS units 250 as known in the art are the battery 258. As much as 50% of this bulk may be saved. Additionally, batteries comprises a large fraction of thee cost of a UPS system. In addition, UPS batteries typically need periodic replacing. A much as half of this cost may be saved using the current invention. Additionally, the modular architecture of using bay and external battery packs enable easy, fast and user friendly battery replacement as well as upgrade to longer operation duration. Cost, weight and bulk is saved in the system 30 of the current invention by the fact that some UPS elements are now unnecessary and eliminated.

Another optional advantage of the current invention is the ease and technically simple way to adapt the UPCPU to main AC electrical power standards such as 100, 110 or 120 Volts and 50 or 60 Hz. A UPS of the art is commonly restricted, or factory adapted to the main AC standards. Specifically this adaptation may be needed at the DC/AC and filter 262 (seen in FIG. 2). In contrast, universal AC/DC converters and battery chargers which operate with any one of the main AC standards are common technology. These technologies may involve automatic adaptation of the voltage reducing ratio of a transformer, or may rely on rectification of the AC voltage, and DC/DC step-down to provide the desirable output voltage. It is clear to see that the fact that the invention does not use a DC/AC inverter, or output AC filtering, adaptation to different main AC standards is easier than in systems of the art.

Another optional advantage of the invention is apparent when you analyze the way the system of the art is handling poor quality main AC power. In some UPS systems of the art, as long as the AC power is within acceptable range of parameters, in order to reduce inefficiencies during normal operation, power from the input filter 252 is feeding the output filter 262, bypassing the AC/DC converter 254 and DC/AC inverter 260. In “line-interactive” UPS systems, an autotransformer with automatic switching of windings is used for compensating for small variations in the main AC voltage. This expensive and bulky element is not needed in the current invention as the variations in AC input voltage are compensated by one or combination of: 12V converter 453, and DC/DC converter 458.

In an exemplary embodiment of the invention UPCPU 300 is missing the internal battery pack, and only uses bay and/or external battery packs. In this exemplary embodiment of the invention, elements that are added to PCPS 100 of the art in order to convert is to UPCPU 300 of the invention are merely the input selector, the real time monitoring circuit and USB COM, and the connectors to battery packs and optionally for the display. Such modification may require no additional space, and requires only minimal added cost over a standard PCPS, yet offers upgradability by adding bay or external battery packs.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed:

1. A uninterruptable PC Power Unit (UPCPU) for a personal computer (PC) comprising:
an AC main power input;
a surge protector capable of filtering AC power received from said AC main power input;
an AC to DC converter, capable of producing DC power from AC power received from said surge protector;
an internal battery pack, capable of storing power received from said AC to DC converter;
an input selector, capable of selecting:
the DC power from said DC to DC converter, when AC power is available at said AC main input; and
the DC power from said internal battery pack, when AC power is not available at said AC main input;
a DC to DC converter, capable of receiving DC power from said input selector, and supplying a plurality of voltages needed for operational of a PC to power supply connectors,
wherein the UPCPU is sized to replace a power supply of a PC.

2. The UPCPU of claim 2, further comprising at least one external battery, wherein said input selector is further capable of selecting the DC power from said external battery when AC power is not available at said AC main input; and wherein said at least one external battery is capable of being charged by power received from the UPCPU, and wherein said at least one external battery is capable of supplying power to said input selector.

3. The UPCPU of claim 2, further comprising at least one external battery, wherein said at least one external battery is sized to be installed in at least one of the 5.25″ bays of said PC.

4. The UPCPU of claim 2, further comprising at least one external battery, wherein said at least one external battery is sized to be installed in at least one of the 3.5″ bays of said PC.

5. The UPCPU of claim 2, further comprising at least one external battery, wherein said at least one external battery is installed outside said PC.

6. The UPCPU of claim 1, further comprising:
a real time monitoring circuit capable of monitoring the operation of the UPCPU; and
a USB communication function capable of communication with the PC in which said UPCPU is installed.

7. The UPCPU of claim 2, wherein said least one external battery further comprises a balanced charger.

8. The UPCPU of claim 7, wherein said balanced charger comprises a communication function capable of communicating with said USB communication function.

9. The UPCPU of claim 8, wherein said communication function in a balanced charger of an external battery is capable of providing to said USB communication function information indicative of the type of said external battery.

10. The UPCPU of claim 8, wherein said communication function in a balanced charger of an external battery is capable of providing to said USB communication function information indicative of the state of charging of said external battery.

11. The UPCPU of claim 1, further comprising an external power connector capable of providing uninterruptable DC power.

12. The UPCPU of claim 11, further comprising an external power connector receiving uninterruptable DC power from said input selector.

13. The UPCPU of claim 12, further comprising an external power connector, receiving uninterruptable DC power from said DC to DC converter.

14. The UPCPU of claim 11, wherein said external power connector is capable of powering a display.

15. The UPCPU of claim 1, wherein said AC to DC converter is a 12 Volts converter.

16. The UPCPU of claim 6, wherein said real time monitoring circuit is capable of forcing safe shutdown of said PC when AC power is not available at said AC main input.

17. The UPCPU of claim 16, wherein said forcing safe shutdown of said PC is performed when charge level in batteries internal and external to the UPCPU is below a predefined threshold.

18. The UPCPU of claim 17, wherein said forcing safe shutdown of said PC is preceded by disconnection of power to non essential PC hardware components to save power and extend the time duration that power is available from the batteries.

19. The UPCPU of claim 17, wherein the disconnection of power to non essential PC hardware components comprises disconnecting at least component selected from a group consisting of: display; CD; DVD; and graphic card.

20. The UPCPU of claim 17, wherein said forcing safe shutdown of said PC is preceded by reducing the operation speed and CPU power usage.
